(19) United States
(12) Patent Application Publication
(10) Pub. No.: US 2011/0254770 A1
(43) Pub. Date: Oct. 20, 2011

(54) OPTICAL DEVICE

(76) Inventor: Jian LIU, Shanghai (CN)

(21) Appl. No.: 13/090,145

(22) Filed: Apr. 19, 2011

(30) Foreign Application Priority Data
Apr. 20, 2010 (CN) 201010151640.4

(51) Int. Cl. G06F 3/033

(52) U.S. Cl. 345/166

(57) ABSTRACT

An optical device comprises an outer case including a light transmitting work area, an optical lens inside the outer case, and an optical sensor device inside the outer case, wherein an imaging pathway from the work area through the optical lens to the optical sensor device is non-perpendicular to the work area.

### TECHNICAL FIELD

The present invention relates to an optical device, and in particular relates to an optical device capable of effectively preventing erroneous operations.

### BACKGROUND

Optical equipment, including optical mice and optical navigation equipment, is becoming increasingly popular because of its practical use and convenience. An example of existing optical navigation equipment is described in U.S. Pat. No. 7,244,925, where the optical navigation equipment includes a case 8, a work plane 20 on the upper surface of case 8, and an illumination pathway and an imaging pathway inside case 8. Light emitted by a light source 10 passes through a cover piece 16 and is incident onto a reflecting surface, which reflects the light to work plane 20, forming the illumination pathway. The imaging pathway includes a sensor 12 placed on a circuit board 13 and a lens group 14 placed on a cover piece that covers sensor 12. Work plane 20 includes a work area for transmitting light. Light passes through work area 20 and is incident on lens group 14 after being reflected by an object located in the work area. Lens group 14 transfers the image of said object to sensor 12, and circuit board 13 processes the image to form electrical signals. The optical navigation equipment described in this United States patent can effectively monitor the movement of the object located in work area 20 to achieve optical navigation.

However, the following problems are present in the above-described equipment. First, if the optical navigation equipment is affected by abnormal objects above work area 20, or if some parasitic light passes through the light transmitting work area, the resultant changes to the light received by lens group 14 may cause sensor 12 to generate incorrect electrical signals, leading to erroneous operations. Additionally, a light transmitting area of cover piece 16 above light source 10 sags downward, as a result of which only light incident on the center point location of the light transmitting area of cover piece 16 will come out of cover piece 16 perpendicularly, and the remaining light will be transmitted at an angle toward the light transmitting area of cover piece 16. As a result, a large amount of light is reflected back, resulting in low efficiency of light source 10.

Therefore, a new optical device is needed to resolve the above-described defects of existing optical devices, thereby effectively reducing or preventing erroneous operations and offering efficient utilization of the light source.

### SUMMARY

An optical device consistent with embodiments of the present invention includes an outer case including a light transmitting work area, an optical lens inside the outer case, and an optical sensor device inside the outer case, wherein an imaging pathway from the work area through the optical lens to the optical sensor device is non-perpendicular to the work area.

An optical device consistent with embodiments of the present invention includes an outer case including a light transmitting work area, an optical lens inside the outer case, and an optical sensor device inside the outer case, wherein the optical lens is not located directly beneath the work area.

An optical navigation device consistent with embodiments of the present invention includes an outer case including a light transmitting work area an optical lens inside the outer case, and an optical sensor device inside the outer case, wherein an imaging pathway extending from the work area through the optical lens to the optical sensor device is non-perpendicular to the work area.

An optical navigation device consistent with embodiments of the present invention includes an outer case including a light transmitting work area, an optical lens inside the outer case, and an optical sensor device inside the outer case, wherein the optical lens is not located directly beneath the work area.

An optical device consistent with embodiments of the present invention includes a light source, a light transmitting surface having an arc-shaped area above the light source, and a reflecting surface.

Features and advantages consistent with the invention will be set forth in part in the description which follows, and in part will be obvious from the description, or may be learned by practice of the invention. Such features and advantages will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments of the invention and together with the description, serve to explain the principles of the invention. In the drawings:

FIG. 1 illustrates the structure of an existing optical device;

FIG. 2 illustrates the structure of an optical device consistent with a first embodiment of the present invention;

FIG. 3 illustrates the structure of an optical device consistent with another embodiment of the present invention; and

FIG. 4 illustrates the structure of an optical device consistent with yet another embodiment of the present invention.

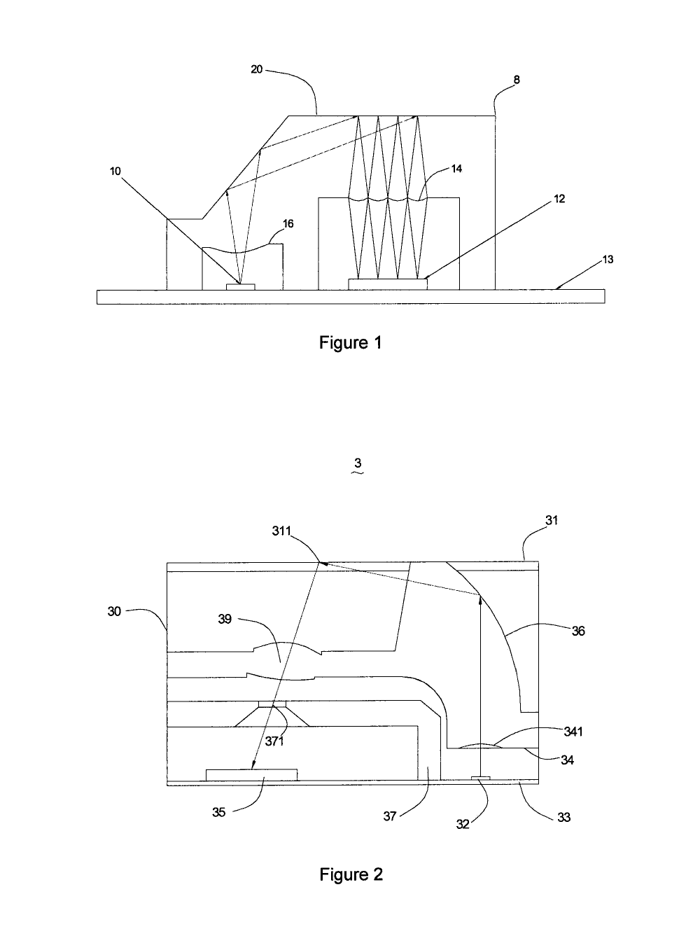

### DESCRIPTION OF THE EMBODIMENTS

Hereinafter, embodiments consistent with the present invention will be described with reference to the drawings. Wherever possible, the same reference numbers will be used throughout the drawings to refer to the same or like parts.

The following description uses an optical navigation device as an example. However, it is to be understood that the present invention is applicable to other optical devices as well, such as optical mice, etc.

FIG. 2 illustrates the structure of an optical device 3 consistent with a first embodiment of the present invention. Optical device 3 includes an outer case 30. A work plane 31 is configured on the upper part of outer case 30 and a light transmitting work area 311 is configured on work plane 31. Outer case 30 also includes a circuit board 33 in the lower part thereof, with an optical sensor device 35 on circuit board 33. Optical sensor device 35 may be an optical sensor array or a single sensor. A cover piece 37 covers optical sensor device 35 and has a light transmitting opening 371 thereon. An optical lens 39 is configured above light transmitting opening 371. Optical lens 39 may be a single lens or have another form such as, for example, a lens array. Light transmitting opening 371 may comprise transparent material that transmits light.

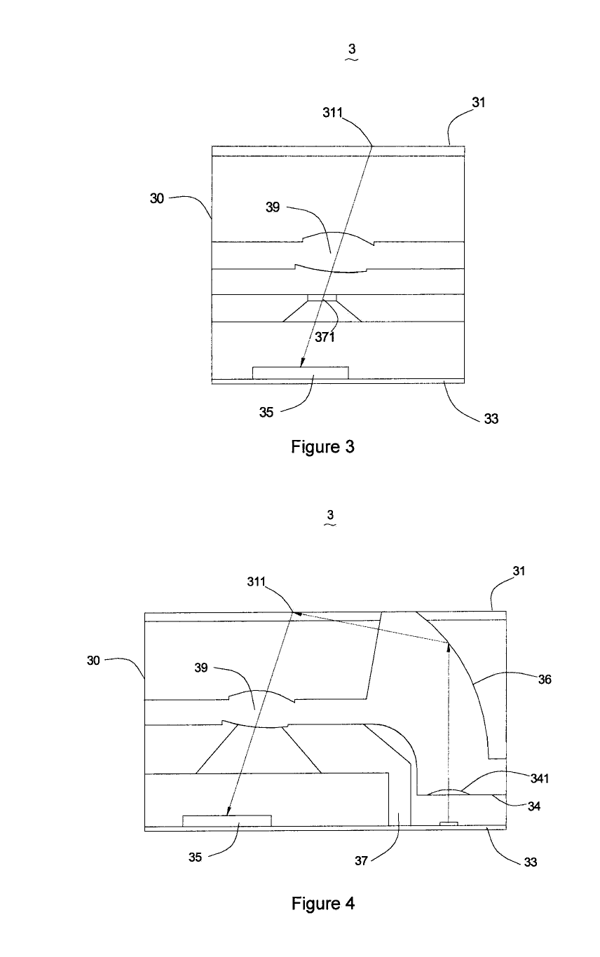

Light coming from work area 311 is refracted by lens 39, passes through light transmitting opening 371, and forms an image on optical sensor device 35, defining an imaging pathway, which is reproduced in FIG. 3. Consistent with embodiments of the present invention, optical device 3 is configured such that light incident on lens 39 from work area 311 is not perpendicular to work area 311. For example, lens 39 may be configured such that the principal plane of lens 39 forms an angle with the plane in which work area 311 is located. The angle may be larger than 0 degrees but less than 7.5 degrees, but is not limited thereto. As a result, the imaging pathway from work area 311, through lens 39 and light transmitting opening 371 to optical sensor device 35, is not perpendicular to work area 311. The invention is of course not limited to having a slanted lens 39, but may adopt any other configuration that can deflect refracted light, prevent the light coming from work area 311 from being perpendicularly incident on lens 39, and result in an imaging pathway non-perpendicular to work area 311.

Consistent with embodiments of the present invention, because the imaging pathway and/or the light incident on lens 39 from work area 311 is non-perpendicular to work area 311, erroneous operations are effectively prevented. For example, parasitic light entering work area 311 perpendicularly will not reach lens 39 and form an image on optical sensor array 35, because lens 39 is not directly beneath work area 311. On the other hand, parasitic light that does reach lens 39 and at an angle with work area 311 will have so limited intensity as not to result in erroneous operations by forming an image on optical sensor device 35, because most of the oblique light is reflected back by work area 311.

FIG. 3 shows that optical sensor device 35 on circuit board 33 is parallel to work plane 31 on which work area 311 is located. Alternatively, optical sensor device 35 may be configured perpendicular to the imaging pathway, i.e., at an angle with work plane 31.

Referring back to FIG. 2, a light source 32 is also configured inside outer case 30. A light transmitting plate 34 is placed above light source 32. Light transmitting plate 34 has an arc-shaped area 341. In the present embodiment, arc-shaped area 341 has a circular arc shape, whereas light source 32 is placed at the center of the circle to which circular arc-shaped area 341 belongs. Thus, light emitted by light source 32 passes through arc-shaped area 341 in directions substantially perpendicular thereto, thereby minimizing reflection and realizing optimal light source utilization efficiency.

It is to be understood that, although FIG. 2 illustrates a circular arc-shaped area 341, alternative designs can be adopted as long as light from light source 32 passes through an area of light transmitting plate 34 at a relatively small angle so as to reduce reflection.

Still referring to FIG. 2, an arc-shaped reflecting surface 36 is also placed inside outer case 30. Light emitted by light source 32, after passing through arc-shaped area 341, is reflected by reflecting surface 36 onto work area 311, and illuminates objects on the work area 311, such as fingers, etc. An illumination path is thus defined as a path of light from light source 32, through arc-shaped area 341, and from reflecting surface 36 to reach work area 311. Optical device 3 illustrated in FIG. 2 and described herein allows for optimum illumination of work area 311 by light source 32 and better utilization efficiency of light source 32, with reduced light losses.

Consistent with embodiments of the present invention, reflecting surface 36 may be a parabola-shaped reflecting surface and light source 32 is located at the focal point of the parabola. Light emitted by light source 32, after passing through arc-shaped area 341, is reflected by reflecting surface 36 and uniformly illuminates work area 311. Reflecting surface 36 may have other shapes, too, such as an elliptical shape, in which case light emitted by light source 32 may be concentrated on work area 311.

The configuration of the imaging pathway shown in FIG. 3 need not be always used together with an imaging pathway comprised in the configuration shown in FIG. 2. An external light to illuminate work area 311 can also be used with the imaging pathway configuration of FIG. 3 to prevent erroneous operations, consistent with embodiments of the present invention.

FIG. 4 illustrates a structural diagram of yet another embodiment of the present invention. As shown in FIG. 4, lens 39 is configured directly on cover piece 37, in the location of light transmitting opening 371 of FIG. 3, resulting in a simpler structure than that shown in FIG. 3. In FIG. 4, the principal plane of lens 39 is configured at an angle with work plane 31 where work area 311 is located.

In summary, embodiments of the present invention provide an optical device that reduces or prevents erroneous operations and improves the utilization efficiency of the light source.

It will be apparent to those skilled in the art that various modifications and variations can be made in the disclosed embodiments without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An optical device comprising:
an outer case including a light transmitting work area;
an optical lens inside the outer case; and
an optical sensor device inside the outer case,
wherein an imaging pathway from the work area through the optical lens to the optical sensor device is non-perpendicular to the work area.

2. The optical device according to claim 1, further comprising a cover piece covering the optical sensor device, the cover piece having a light transmitting opening.

3. The optical device according to claim 2, wherein the optical lens is placed above the light transmitting opening.

4. The optical device according to claim 2, wherein the light transmitting opening comprises a through-hole in the cover piece.

5. The optical device according to claim 2, wherein the light transmitting opening comprises a transparent material.

6. The optical device according to claim 1, wherein the optical lens projects light reflected by an object on the work area onto the optical sensor device to form an image on the optical sensor device.

7. The optical device according to claim 1, wherein the optical lens comprises a single lens or a lens array.

8. The optical device according to claim 1, wherein a principal plane of the optical lens and a plane in which the work area is located form an angle larger than 0 degree.

9. The optical device according to claim 5, wherein the angle is smaller than 7.5 degrees.

10. The optical device according to claim 1, wherein a plane in which the optical sensor device is located is perpendicular to the imaging pathway.

11. The optical device according to claim 1, wherein a plane in which the optical sensor device is located is parallel to a plane in which the work area is located.

12. The optical device according to claim 1, further comprising:
a light source;
a light transmitting surface having an arc-shaped area above the light source; and
a reflecting surface.

13. The optical device according to claim 12, wherein light emitted by the light source passes substantially perpendicularly through the arc-shaped area.

14. The optical device according to claim 12, wherein the arc-shaped area has a circular arc shape, the light source being placed at the center of the circle to which the circular arc belongs.

15. The optical device according to claim 12, wherein the reflecting surface is parabola-shaped, the light source being located at a focal point of the parabola.

16. The optical device according to claim 12, wherein the reflecting surface is elliptical, the light source being located at a focal point of the reflecting surface.

17. An optical device comprising:
an outer case including a light transmitting work area;
an optical lens inside the outer case; and
an optical sensor device inside the outer case,
wherein the optical lens is not located directly beneath the work area.

18. The optical device according to claim 17, further comprising a cover piece covering the optical sensor device, the cover piece having a light transmitting opening.

19. The optical device according to claim 18, wherein the light transmitting opening comprises a through-hole in the cover piece.

20. The optical device according to claim 18, wherein the light transmitting opening comprises a transparent material.

21. The optical device according to claim 17, wherein the optical lens projects light reflected by an object on the work area onto the optical sensor device to form an image on the optical sensor device.

22. The optical device according to claim 17, wherein the optical lens comprises a lens or a lens array.

23. The optical device according to claim 17, further comprising:
a light source
a light transmitting surface having an arc-shaped area above the light source; and
a reflecting surface.

24. The optical device according to claim 23, wherein the arc-shaped area has a circular arc shape, the light source being placed at the center of the circle to which the circular arc belongs.

25. The optical device according to claim 23, wherein the reflecting surface is elliptical, the light source being located at a focal point of the reflecting surface.

26. The optical device according to claim 23, wherein the reflecting surface is parabola-shaped, the light source being located at a focal point of the parabola.

27. An optical navigation device comprising:
an outer case including a light transmitting work area;
an optical lens inside the outer case; and
an optical sensor device inside the outer case;
wherein an imaging pathway extending from the work area through the optical lens to the optical sensor device is non-perpendicular to the work area.

28. The optical navigation device according to claim 27, further comprising a cover piece covering the optical sensor device, the cover piece having a light transmitting opening.

29. The optical navigation device according to claim 27, wherein the optical lens projects light reflected by an object on the work area onto the optical sensor device to form an image on the optical sensor device.

30. The optical navigation device according to claim 27, further comprising:
a light source;
a light transmitting surface having an arc-shaped area above the light source; and
a reflecting surface.

31. The optical navigation device according to claim 30, wherein light emitted by the light source passes substantially perpendicularly through the arc-shaped area.

32. The optical navigation device according to claim 30, wherein the arc-shaped area has a circular arc shape, the light source being placed at the center of the circle to which the circular arc belongs.

33. An optical navigation device comprising:
an outer case including a light transmitting work area;
an optical lens inside the outer case; and
an optical sensor device inside the outer case,
wherein the optical lens is not located directly beneath the work area.

34. The optical navigation device according to claim 33, further comprising a cover piece covering the optical sensor device, the cover piece having a light transmitting opening.

35. The optical navigation device according to claim 33, wherein the optical lens projects light reflected by an object on the work area onto the optical sensor device to form an image on the optical sensor device.

36. The optical navigation device according to claim 33, further comprising:
a light source;
a light transmitting surface having an arc-shaped area above the light source; and
a reflecting surface.

37. The optical navigation device according to claim 36, wherein light emitted by the light source passes substantially perpendicularly through the arc-shaped area.

38. The optical navigation device according to claim 36, wherein the arc-shaped area has a circular arc shape, the light source being placed at the center of the circle to which the circular arc belongs.

39. An optical device, comprising:
a light source;
a light transmitting surface having an arc-shaped area above the light source; and
a reflecting surface.

40. The optical device according to claim 39, further comprising an outer case enclosing the light source, the light transmitting surface, and the reflecting surface.

41. The optical device according to claim 39, wherein the arc-shaped area has a circular arc shape, the light source being placed at the center of the circular arc.

42. The optical device according to claim 39, wherein the reflecting surface is elliptical, the light source being located at a focal point of the reflecting surface.

43. The optical device according to claim 39, wherein the reflecting surface is parabola-shaped, the light source being located at a focal point of the parabola.
